(19) United States
(12) Patent Application Publication
(10) Pub. No.: US 2024/0174176 A1
(43) Pub. Date: May 30, 2024

(54) Multiview Side Mirror Device And Method Of Use

(71) Applicants: Emmett Curry, Panama City, FL (US); Janea Burrow, Panama City, FL (US)

(72) Inventors: Emmett Curry, Panama City, FL (US); Janea Burrow, Panama City, FL (US)

(21) Appl. No.: 18/071,034

(22) Filed: Nov. 29, 2022

(51) Int. Cl. B60R 1/072; G02B 7/182

(52) U.S. Cl. CPC B60R 1/072; G02B 7/182

(57) ABSTRACT

A multiview side mirror device for eliminating blind spots includes a shell that is mountable to a vehicle so that a front face of the shell, which is open and substantially planar, faces a rear of the vehicle. First and second mirrors are operationally engaged to first and second actuators, respectively, which are attached to and positioned in the shell and operationally engageable to a side mirror controller of the vehicle. The first mirror is substantially planar while a front facet of the second mirror curves convexly between its opposing ends. The first and second mirrors are positioned in an upper and lower portions of the front face, respectively. The side mirror controller can selectively actuate the first and second actuators to corotate the first and second mirrors, respectively, about their respective horizontal axes, and to counterrotate the first and second mirrors, respectively, about their respective vertical axes.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to side mirror devices and more particularly pertains to a new side mirror device for eliminating blind spots. The present invention discloses a side mirror device having a top mirror and a bottom mirror attached to actuators that enable corotation about their respective horizontal axes and counterrotation about their respective vertical axes, thereby allowing a driver to eliminate a blind spot.

### (2) Description of Related Art Including Information Disclosed Under 37 CFR 1.97 and 1.98

The prior art relates to side mirror devices, which may comprise two piece mirrors wherein a bottom piece is directly downwardly automatically when a vehicle is placed in reverse and two piece mirrors wherein each piece has a different angle, and the angles are fixed relative to each other.

One of the inventors of the present invention is sole inventor of U.S. patent application Ser. No. 15/274,490, which discloses a side mirror device comprising a top mirror and a bottom mirror, each attached to a respective actuator, with the actuators each having their own controller. It was not anticipated that by this inventor or the coinventor, nor would it have been anticipated by others skilled in the art of movable mirrors, that the actuators of such a side mirror device could be enable corotation of the top mirror and the bottom mirror about their respective horizontal axes and counterrotation about their respective vertical axes under the direction of a single side mirror controller.

What is lacking in the prior art is a side mirror device comprising a top mirror and a bottom mirror attached to actuators enabling corotation about their respective horizontal axes and counterrotation about their respective vertical axes using a single side mirror controller. Further lacking in the prior art is such a side mirror device wherein the bottom mirror is curved convexly between its opposing ends and, optionally, between its top and bottom edges.

### BRIEF SUMMARY OF THE INVENTION

An embodiment of the disclosure meets the needs presented above by generally comprising a shell, which defines an interior space and which is configured to be mountable to one of a driver side and a passenger side of a vehicle so that a front face of the shell faces a rear of the vehicle. The front face is open and substantially planar. A first actuator is attached to the shell, is positioned in the interior space, and is configured to be operationally engaged to a side mirror controller of the vehicle. A first mirror is operationally engaged to the first actuator. The first mirror is substantially planar, is positioned in an upper portion of the front face, and extends from proximate to opposed sides of the shell.

A second actuator is attached to the shell, is positioned in the interior space, and is configured to be operationally engaged to the side mirror controller of the vehicle. A second mirror is operationally engaged to the second actuator. The second mirror is positioned in a lower portion of the front face and extends from proximate to the opposed sides of the shell. A front facet of the second mirror curves convexly between its opposing ends. The first actuator and the second actuator are configured to be selectively actuated by the side mirror controller to corotate the first mirror and the second mirror, respectively, about their respective horizontal axes, and to be selectively actuated by the side mirror controller to counterrotate the first mirror and the second mirror, respectively, about their respective vertical axes.

Another embodiment of the invention includes a multiview side mirror system, which comprises a multiview side mirror device that has been mounted to one of a driver side and a passenger side of a vehicle and operationally engaged to a side mirror controller of the vehicle. The side mirror controller thus is enabled to selectively actuate the first actuator and the second actuator to corotate the first mirror and the second mirror, respectively, about their respective horizontal axes, and to selectively actuate the first actuator and the second actuator to counterrotate the first mirror and the second mirror, respectively, about their respective vertical axes.

Yet another embodiment of the invention includes a method of eliminating blind spots, which comprises a provision steps, which entail providing a vehicle with a factory installed side mirror and a multiview side mirror device, per the disclosure above. Preparatory steps entail detachment of the factory installed side mirror disconnecting its signaling and powering cable from a wiring coupler of the vehicle. Installation steps entail attachment of a tubular attachment piece of the multiview side mirror device to the vehicle and connection of a connector of the signaling and powering cable to the wiring coupler. A use step of the method is selectively positioning the first mirror and the second mirror to eliminate a blind spot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a multiview side mirror device according to an embodiment of the disclosure.

FIG. 2 is an isometric perspective view of an embodiment of the disclosure.

FIG. 3 is an isometric perspective view of an embodiment of the disclosure.

FIG. 4 is a front view of an embodiment of the disclosure.

FIG. 5 is a cross-sectional view of an embodiment of the disclosure.

FIG. 6 is an in-use view of an embodiment of the disclosure.

FIG. 7 is a flow diagram for a method utilizing an embodiment of the disclosure.

### DETAILED DESCRIPTION OF THE INVENTION

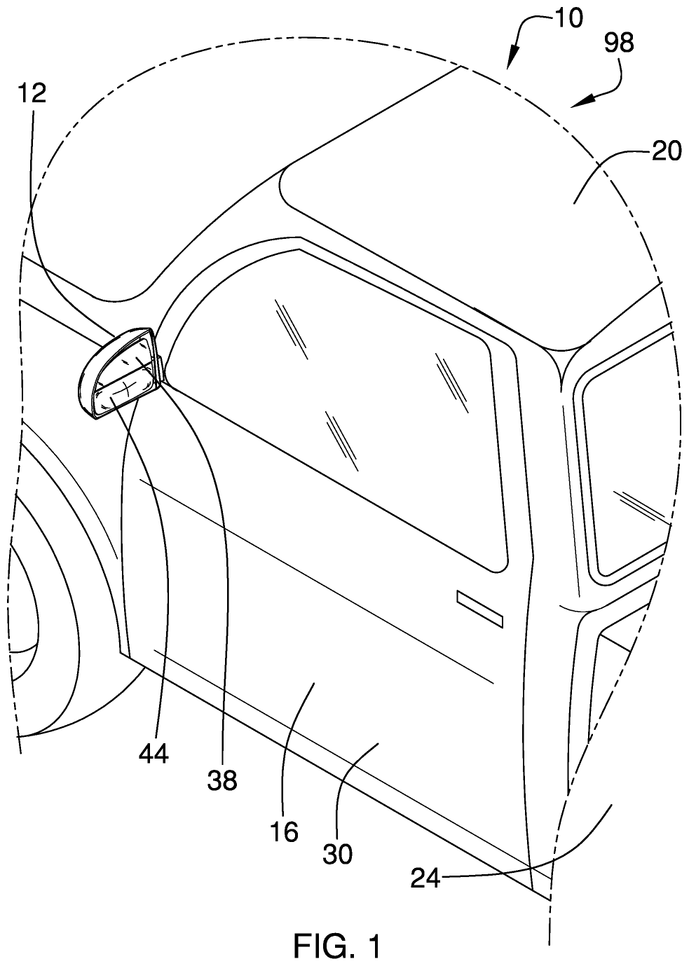

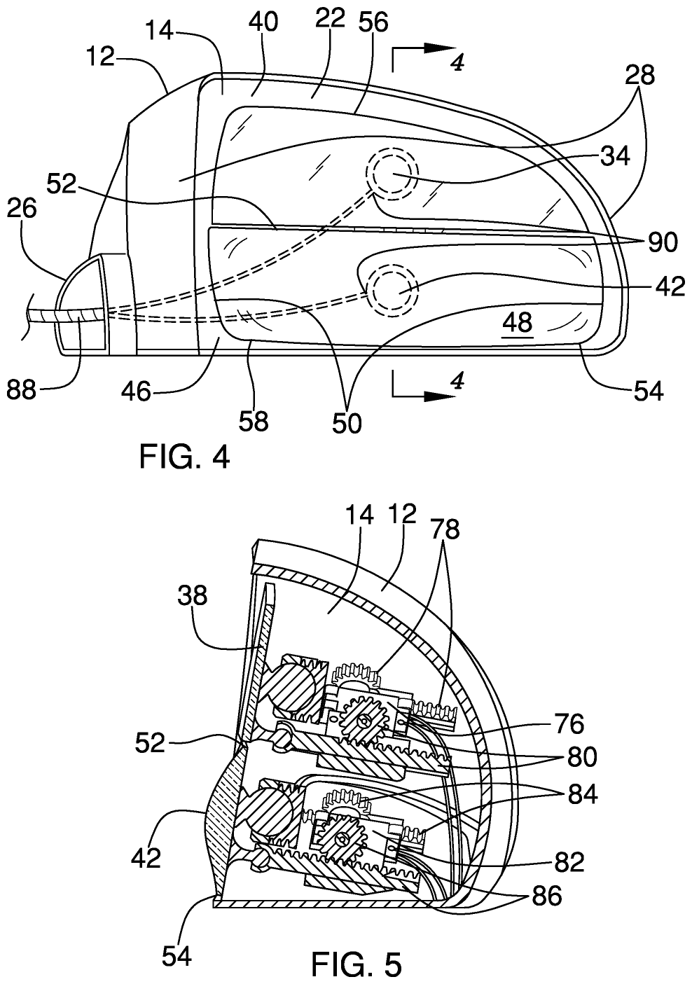

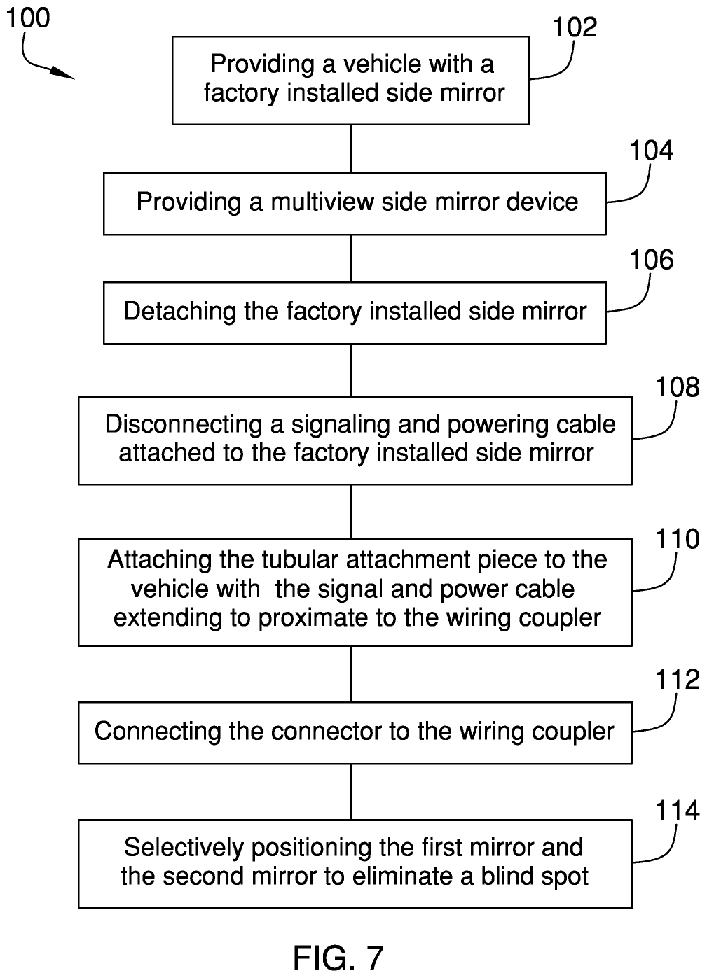

With reference now to the drawings, and in particular to FIGS. 1 through 7 thereof, a new side mirror device embodying the principles and concepts of an embodiment of the disclosure and generally designated by the reference numeral 10 will be described.

As best illustrated in FIGS. 1 through 7, the multiview side mirror device 10 generally comprises a shell 12, which defines an interior space 14 and which is configured to be mountable to one of a driver side 16 and a passenger side 18 of a vehicle 20 so that a front face 22 of the shell 12 faces a rear 24 of the vehicle 20. The front face 22 is open and substantially planar. The shell 12 is anticipated be shaped in various manners to substantially match factory installed side mirror assemblies that are to be replaced by a multiview side mirror device 10.

A tubular attachment piece 26 is attached to a respective opposed side 28 of the shell 12 and is configured to be mounted to an associated one of the driver side 16 and the passenger side 18 of the vehicle 20, typically one of the driver's door 30 and the passenger's door 32. As with the shell 12, the tubular attachment piece 26 may be configured to substantially match that of a factory installed side mirror assembly, thereby facilitating installation of the multiview side mirror device 10. The tubular attachment piece 26 typically would be attached by means of the nuts and the bolts used for the factory installed side mirror assemblies. The present invention also anticipates the multiview side mirror device 10 being factory installed as original equipment.

A first actuator 34 is attached to the shell 12, is positioned in the interior space 14, and is configured to be operationally engaged to a side mirror controller 36 of the vehicle 20. A first mirror 38 is operationally engaged to the first actuator 34. The first mirror 38 is substantially planar, is positioned in an upper portion 40 of the front face 22, and extends from proximate to the opposed sides 28 of the shell 12. A second actuator 42 also is attached to the shell 12, is positioned in the interior space 14, and is configured to be operationally engaged to the side mirror controller 36 of the vehicle 20. A second mirror 44 is operationally engaged to the second actuator 42. The second mirror 44 is positioned in a lower portion 46 of the front face 22 and extends from proximate to the opposed sides 28 of the shell 12. A front facet 48 of the second mirror 44 curves convexly between its opposing ends 50.

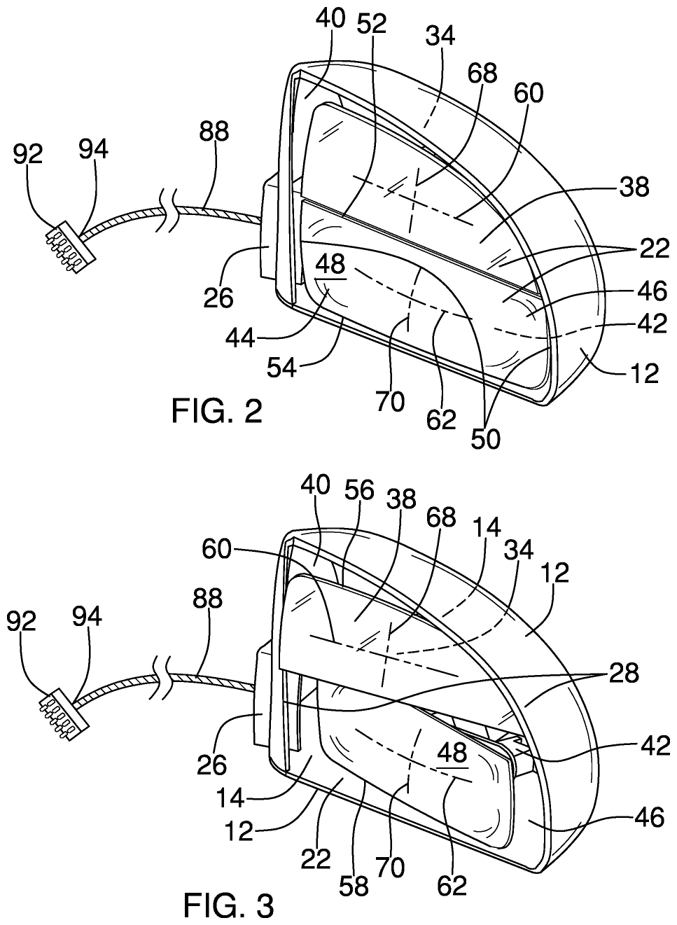

As shown most clearly in FIG. 5, the front facet 48 also curves convexly from a top edge 52 to a bottom edge 54 of the second mirror 44. A perimeter 56 of the first mirror 38 and a circumference 58 of the second mirror 44 may be shaped so that the first mirror 38 and the second mirror 44 together substantially match the front face 22 of the shell 12, as shown in FIG. 2.

The first actuator 34 and the second actuator 42 are configured to be selectively actuated by the side mirror controller 36 to corotate the first mirror 38 and the second mirror 44, respectively, about their horizontal axes (60 and 62, respectively). More plainly, and by means of example only, the first mirror 38 and the second mirror 44 are rotated “up” and “down” concurrently upon manipulation of the corresponding “Up Button” 64 and “Down Button” 66 of the side mirror controller 36. The first actuator 34 and the second actuator 42 also are configured to be selectively actuated by the side mirror controller 36 to counterrotate the first mirror 38 and the second mirror 44, respectively, about their respective vertical axes (68 and 70, respectively). Again, more plainly, and by means of example only, the first mirror 38 and the second mirror 44 are rotated “left” and “right”, respectively, upon manipulation of the “Left Button” 72 of the side mirror controller 36. The first mirror 38 and the second mirror 44 are rotated “right” and “left”, respectively, upon manipulation of the “Right Button” 74 of the side mirror controller 36. As shown in FIGS. 2 and 3 for a multiview side mirror device 10 configured to be mountable to the passenger side 18 of the vehicle 20, the first mirror 38 and the second mirror 44 are shown in a neutral position in FIG. 2 and have been counterrotated to the left and to the right, respectively, in FIG. 3.

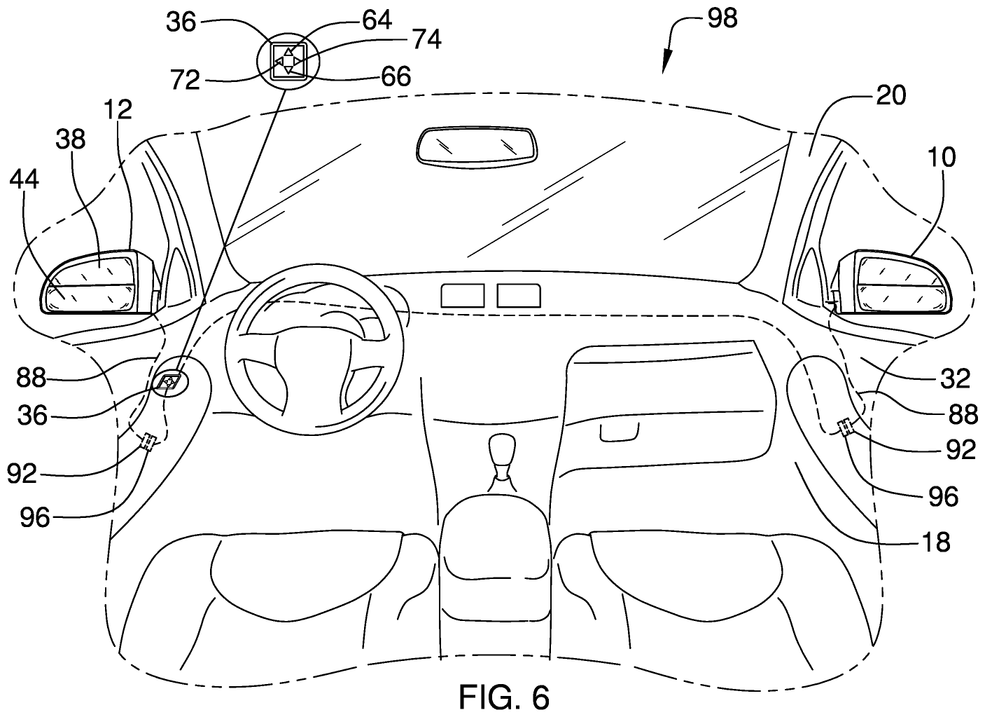

Various types of side mirror controllers 36, such as pushbutton controllers, as shown in FIG. 6, joystick controllers, and the like, are used in vehicles 20 and the present invention anticipates the multiview side mirror device 10 being operationally engageable to, and operable by, these various types of side mirror controllers 36.

The first actuator 34 may comprise a first servomotor 76, a first gearset 78, and a second gearset 80. The first gearset 78 is operationally engaged to the first servomotor 76 and to the first mirror 38 so that the first servomotor 76 is positioned to selectively motivate the first gearset 78 to rotate the first mirror 38 about its vertical axis 68. The second gearset 80 is operationally engaged to the first servomotor 76 and to the first mirror 38 so that the first servomotor 76 is positioned to selectively motivate the second gearset 80 to rotate the first mirror 38 about its horizontal axis 60.

Similarly, the second actuator 42 may comprise a second servomotor 82, a first gearbox 84, and a second gearbox 86. The first gearbox 84 is operationally engaged to the second servomotor 82 and to the second mirror 44 so that the second servomotor 82 is positioned to selectively motivate the first gearbox 84 to rotate the second mirror 44 about its vertical axis 70. The second gearbox 86 is operationally engaged to the second servomotor 82 and to the second mirror 44 so that the second servomotor 82 is positioned to selectively motivate the second gearbox 86 to rotate the second mirror 44 about its horizontal axis 62.

The present invention also anticipates the first actuator 34 and the second actuator 42 comprising other actuating means known to those skilled in the art of movable mirrors. For example, the first actuator 34 and the second actuator 42 may comprise two first servomotors 76 and two second servomotors 82, respectively. One of the first servomotors 76 and one of the second servomotors 82 would be responsible for corotation of the first mirror 38 and the second mirror 44, respectively, about their horizontal axes, 60 and 62, respectively. The other of the first servomotors 76 and the other of the second servomotors 82 would be responsible for counterrotation of the first mirror 38 and the second mirror 44, respectively, about their vertical axes, 68 and 70, respectively. Such a configuration could be implemented by means of pivoting attachment of each of the first mirror 38 and the second mirror 44 to the first actuator 34 and the second actuator 42, as shown in FIG. 5.

As shown in FIGS. 2-4, a signal and power cable 88 is operationally attached by its first end 90 to the first actuator 34 and to the second actuator 42. The signal and power cable 88 extends from the shell 12 through the tubular attachment piece 26. A connector 92 is attached to a second end 94 of the signal and power cable 88 and is configured to be connected to a wiring coupler 96 of the vehicle 20 so that the first actuator 34 and the second actuator 42 are operationally engaged to the side mirror controller 36 of the vehicle 20. Typically, the wiring connector 92 is positioned behind a door panel of the vehicle 20.

The present invention also anticipates a multiview side mirror system 98, which comprises a multiview side mirror device 10 that has been mounted to one of a driver side 16 and a passenger side 18 of a vehicle 20 and operationally engaged to a side mirror controller 36 of the vehicle 20. The side mirror controller 36 thus is enabled to selectively actuate the first actuator 34 and the second actuator 42 to corotate the first mirror 38 and the second mirror 44, respectively, about their horizontal axes, 60 and 62, respectively, and to selectively actuate the first actuator 34 and the second actuator 42 to counterrotate the first mirror 38 and the second mirror 44, respectively, about their vertical axes, 68 and 70, respectively.

In use, the multiview side mirror device 10 enables a method of eliminating blind spots 100, which comprises a first provision step 102 and a second provision step 104, which entail providing a vehicle 20 with a factory installed side mirror and providing a multiview side mirror device 10, per the specification above, respectively. A first preparation step 106 is detaching the factory installed side mirror, which may entail removing an interior door panel from a door of the vehicle 20. A second preparation step 108 is disconnecting a signaling and powering cable attached to the factory installed side mirror from the wiring coupler 96 of the vehicle 20.

A first installation step 110 is attaching the tubular attachment piece 26 to the vehicle 20 with the signal and power cable 88 extending to proximate to the wiring coupler 96. A second installation step 112 is connecting the connector 92 to the wiring coupler 96 so that the first actuator 34 and the second actuator 42 are operationally engaged to the side mirror controller 36 of the vehicle 20. A use step 114 of the method 100 is selectively positioning the first mirror 38 and the second mirror 44, using the side mirror controller 36, to eliminate a blind spot.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multiview side mirror device comprising:
a shell defining an interior space and being configured to be mountable to one of a driver side and a passenger side of a vehicle, such that a front face of the shell faces a rear of the vehicle, the front face being open and substantially planar;
a first actuator attached to the shell, positioned in the interior space, and being configured for operationally engaging a side mirror controller of the vehicle;
a first mirror operationally engaged to the first actuator, the first mirror being substantially planar, positioned in an upper portion of the front face, and extending from proximate to opposed sides of the shell;
a second actuator attached to the shell, positioned in the interior space, and being configured for operationally engaging the side mirror controller of the vehicle; and
a second mirror operationally engaged to the second actuator, the second mirror being positioned in a lower portion of the front face and extending from proximate to the opposed sides of the shell, a front facet of the second mirror curving convexly between opposing ends of the second mirror, wherein the first actuator and the second actuator are configured for being selectively actuated by the side mirror controller for corotating the first mirror and the second mirror, respectively, about their respective horizontal axes, and for being selectively actuated by the side mirror controller for counterrotating the first mirror and the second mirror, respectively, about their respective vertical axes.

2. The multiview side mirror device of claim 1, wherein the front facet curves convexly from a top edge to a bottom edge of the second mirror.

3. The multiview side mirror device of claim 1, further including a tubular attachment piece attached to a respective opposed side of the shell and being configured for mounting to an associated one of the driver side and the passenger side of the vehicle.

4. The multiview side mirror device of claim 1, wherein:
the first actuator comprises:
a first servomotor,
a first gearset operationally engaged to the first servomotor and the first mirror, such that the first servomotor is positioned for selectively motivating the first gearset for rotating the first mirror about its vertical axis, and
a second gearset operationally engaged to the first servomotor and the first mirror, such that the first servomotor is positioned for selectively motivating the second gearset for rotating the first mirror about its horizontal axis; and
the second actuator comprises:
a second servomotor,
a first gearbox operationally engaged to the second servomotor and the second mirror, such that the second servomotor is positioned for selectively motivating the first gearbox for rotating the second mirror about its vertical axis, and
a second gearbox operationally engaged to the second servomotor and the second mirror, such that the second servomotor is positioned for selectively motivating the second gearbox for rotating the second mirror about its horizontal axis.

5. The multiview side mirror device of claim 3, further including:
a signal and power cable operationally attached by a first end to the first actuator and the second actuator, the signal and power cable extending from the shell through the tubular attachment piece; and
a connector attached to a second end of the signal and power cable and being configured for connecting to a wiring coupler of the vehicle, such that the first actuator and the second actuator are operationally engaged to the side mirror controller of the vehicle.

6. The multiview side mirror device of claim 1, further including:
the front facet curving convexly from a top edge to a bottom edge of the second mirror;
a tubular attachment piece attached to a respective opposed side of the shell and being configured for mounting to an associated one of the driver side and the passenger side of the vehicle;
the first actuator comprising:
a first servomotor,
a first gearset operationally engaged to the first servomotor and the first mirror, such that the first servomotor is positioned for selectively motivating the first gearset for rotating the first mirror about its vertical axis, and
a second gearset operationally engaged to the first servomotor and the first mirror, such that the first servomotor is positioned for selectively motivating the second gearset for rotating the first mirror about its horizontal axis;
the second actuator comprising:
a second servomotor,
a first gearbox operationally engaged to the second servomotor and the second mirror, such that the second servomotor is positioned for selectively motivating the first gearbox for rotating the second mirror about its vertical axis, and
a second gearbox operationally engaged to the second servomotor and the second mirror, such that the second servomotor is positioned for selectively motivating the second gearbox for rotating the second mirror about its horizontal axis;
a signal and power cable operationally attached by a first end to the first actuator and the second actuator, the signal and power cable extending from the shell through the tubular attachment piece; and
a connector attached to a second end of the signal and power cable and being configured for connecting to a wiring coupler of the vehicle, such that the first actuator and the second actuator are operationally engaged to the side mirror controller of the vehicle.

7. A multiview side mirror system comprising:
a vehicle;
a shell defining an interior space and mounted to one of a driver side and a passenger side of the vehicle, such that a front face of the shell faces a rear of the vehicle, the front face being open and substantially planar;
a first actuator attached to the shell, positioned in the interior space, and operationally engaged to a side mirror controller of the vehicle;
a first mirror operationally engaged to the first actuator, the first mirror being substantially planar, positioned in an upper portion of the front face, and extending from proximate to opposed sides of the shell;
a second actuator attached to the shell, positioned in the interior space, and configured operationally engaged to the side mirror controller of the vehicle; and
a second mirror operationally engaged to the second actuator, the second mirror being positioned in a lower portion of the front face and extending from proximate to the opposed sides of the shell, a front facet of the second mirror curving convexly between opposing ends of the second mirror, such that the side mirror controller is enabled for selectively actuating the first actuator and the second actuator for corotating the first mirror and the second mirror, respectively, about their respective horizontal axes, and for selectively actuating the first actuator and the second actuator for counterrotating the first mirror and the second mirror, respectively, about their respective vertical axes.

8. The multiview side mirror system of claim 7, wherein the front facet curves convexly from a top edge to a bottom edge of the second mirror.

9. The multiview side mirror system of claim 7, further including a tubular attachment piece attached to a respective opposed side of the shell and mounted to an associated one of the driver side and the passenger side of the vehicle.

10. The multiview side mirror system of claim 7, wherein:
the first actuator comprises:
a first servomotor,
a first gearset operationally engaged to the first servomotor and the first mirror, such that the first servomotor is positioned for selectively motivating the first gearset for rotating the first mirror about its vertical axis, and
a second gearset operationally engaged to the first servomotor and the first mirror, such that the first servomotor is positioned for selectively motivating the second gearset for rotating the first mirror about its horizontal axis; and
the second actuator comprises:
a second servomotor,
a first gearbox operationally engaged to the second servomotor and the second mirror, such that the second servomotor is positioned for selectively motivating the first gearbox for rotating the second mirror about its vertical axis, and
a second gearbox operationally engaged to the second servomotor and the second mirror, such that the second servomotor is positioned for selectively motivating the second gearbox for rotating the second mirror about its horizontal axis.

11. The multiview side mirror system of claim 9, further including:
a signal and power cable operationally attached by a first end to the first actuator and the second actuator, the signal and power cable extending from the shell through the tubular attachment piece; and
a connector attached to a second end of the signal and power cable and being connected to a wiring coupler of the vehicle, such that the first actuator and the second actuator are operationally engaged to the side mirror controller of the vehicle.

12. A method of eliminating blind spots comprising the steps of:
providing a vehicle with a factory installed side mirror;
providing a multiview side mirror device comprising:
a shell defining an interior space and being configured to be mountable to one of a driver side and a passenger side of the vehicle, such that a front face of the shell faces a rear of the vehicle, the front face being open and substantially planar,
a first actuator attached to the shell, positioned in the interior space, and being configured for operationally engaging a side mirror controller of the vehicle,
a first mirror operationally engaged to the first actuator, the first mirror being substantially planar, positioned in an upper portion of the front face, and extending from proximate to opposed sides of the shell,
a second actuator attached to the shell, positioned in the interior space, and being configured for operationally engaging the side mirror controller of the vehicle,
a second mirror operationally engaged to the second actuator, the second mirror being positioned in a lower portion of the front face and extending from proximate to the opposed sides of the shell, a front facet of the second mirror curving convexly between opposing ends of the second mirror, wherein the first actuator and the second actuator are configured for being selectively actuated by the side mirror controller for corotating the first mirror and the second mirror, respectively, about their respective horizontal axes, and for being selectively actuated by the side mirror controller for counterrotating the first mirror and the second mirror, respectively, about their respective vertical axes,
a tubular attachment piece attached to a respective opposed side of the shell and being configured for mounting to an associated one of the driver side and the passenger side of a vehicle,
a signal and power cable operationally attached by a first end to the first actuator and the second actuator, the signal and power cable extending from the shell through the tubular attachment piece, and
a connector attached to a second end of the signal and power cable and being configured for connecting to wiring coupler of the vehicle;
detaching the factory installed side mirror;
disconnecting a signaling and powering cable attached to the factory installed side mirror from the wiring coupler of the vehicle;
attaching the tubular attachment piece to the vehicle with the signal and power cable extending to proximate to the wiring coupler;
connecting the connector to the wiring coupler, such that the first actuator and the second actuator are operationally engaged to the side mirror controller of the vehicle; and
selectively positioning the first mirror and the second mirror to eliminate a blind spot.
